(19) United States
(12) Patent Application Publication
(10) Pub. No.: US 2010/0120318 A1
(43) Pub. Date: May 13, 2010

(54) METHOD OF ASSEMBLING LCD PANEL, INTERFACE APPARATUS, AND ASSEMBLING APPARATUS

(76) Inventors: Chuan-Chieh Lin, Longtan Shiang (TW); Wen-Chueh Pan, Taipei City (TW); Yang-Jiann Fann, Zhongli City (TW); Jer-Shyoung Lai, Banqiao City (TW)

Correspondence Address: Dr. BANGER SHIA;Patent Office of Bang Shia, 102 Lindencrest Ct, Sugar Land, TX, 77479-5201, US

(21) Appl. No.: 12/481,308

(22) Filed: Jun. 9, 2009

(30) Foreign Application Priority Data
Nov. 13, 2008 (TW) 097143869

(51) Int. Cl. H01J 9/00; H01J 9/46

(52) U.S. Cl. 445/24; 445/66

(57) ABSTRACT

The present invention provides a method of assembling an LCD panel, an interface apparatus, and an assembling apparatus. In this invention, the first panel of the LCD panel is mounted on the interface apparatus before being pressed to the second panel of the LCD panel. Therefore, the complexity of the assembly room can be simplified and the cycle time in the assembly room can be shortened by moving the processes of flatly attaching and separating panels out of the assembly room. The interface apparatus is easier to be processed than a glass substrate during operation. The design of the interface apparatus can simplify the mechanisms in the assembly room and shorten the cycle time. The usage of the interface apparatus can reduce the alignment error caused by nonsynchronization of releasing static electricity suckers.

### BACKGROUND OF THE INVENTION

1. Field of the Invention

This invention relates to a method of assembling an LCD panel, an interface apparatus, and an assembling apparatus, and more particularly to a method of assembling an LCD panel, an interface apparatus, and an assembling apparatus which can be applied to assemble a display panel.

2. Description of the Related Art

The manufacturing processes of a liquid crystal display (LCD) includes the steps of forming a color filter film and an array of switch elements, such as a Thin-Film Transistor (TFT), on a glass substrate, aligning, configuring sealants, sealing liquid crystals between two panels, installing an IC driver, and installing a back light unit.

During the sealing of the liquid crystals, one method is to paste two panels with a sealant and then let the sealant harden. Afterwards, the inlet between the two panels is immersed with the liquid crystals in a vacuum chamber, so that the liquid crystals will be injected between the two panels because of pressure differences and capillarity, which are known as the vacuum impregnation method.

Recently, the related community is paying attention to a method which is to drip liquid crystals with regular quantity on an array panel and make the array panel paste a corresponding panel to each other, which is known as the One Drop Filling (ODF) method. Compared with the vacuum impregnation method, the ODF method has advantages such as greatly shortening the injection time of liquid crystals and reduces the usage of liquid crystals, as has been disclosed in U.S. Pat. No. 4,691,995 and U.S. Pat. No. 5,263,888.

However, during the processes of the ODF method, it is important to holding the panels in a vacuum. With the trend of continually enlarging panel sizes (the size an 8^{th} generation panel is almost four times of the 5^{th} generation panel), it is important to support and flatly attach the panels.

Among the existing approaches, a first panel is mainly supported from its bottom by a robot arm (or is attached from its top) to enter a vacuum chamber, a carrying shaft which stretches out from a second press block carries the bottom of the first panel, and the robot arm then exits out of the vacuum chamber. Subsequently, a first press block will come down and attach to the top of the first panel, as has been disclosed in ROC Publication Patent Number 00594297, ROC Patent Number 1257515, and ROC Patent Number 1232418.

Moreover, a panel with a larger size is easy to become deformed, so the panel can not be attached upward only with a static electricity sucker. Instead, the surface of the panel must be quite flatly attached to the static electricity sucker by a vacuum cup or other auxiliary approach, to drive the static electricity sucker to attach the top of the panel. Afterward, a second panel is loaded into the vacuum chamber, and steps such as vacuuming and pressing are performed, as been disclosed in ROC Publication Patent Number 00594297, ROC Patent Number 1257515, and ROC Patent Number 1228183.

However, conversely, the above-mentioned devices which assist the panel to be flatly attached increase the complexity in the vacuum chamber, which not only increase the cost of the assembling equipment, but also raise the probability of failure and demands of repair. Furthermore, because the above-mentioned steps are performed in the vacuum chamber, the cycle time will also increase. Vacuum assembling is a key step in the processes of the ODF method, so the increased cycle time is unfavorable to increase the production capacity. A bigger problem is how to quickly and uniformly release static electricity adsorption force after the first panel assembles to the second panel. The problem is not only an important factor which will influence the alignment precision, but also a big challenge to the processes over and above the 8^{th} generation. Presently, the alignment precision specification of the vacuum pressing equipment over and above 8^{th} generation still has space to be improved, so the alignment precision specifications of the 8^{th} generation provided by all equipment suppliers are looser than that of the 5^{th} generation.

Accordingly, the major scope of the invention is to provide a method of assembling an LCD panel, an interface apparatus, and an assembling apparatus. Particularly, with the method of assembling an LCD panel, the interface apparatus, and the assembling apparatus, the following benefits/advantages can be achieved: (1) the complexity of the assembly room can be simplified and the cycle time in the assembly room can be shortened by moving the processes of flatly attaching and separating panels out of the assembly room, and the gravity of the panel is helpful for the panel to be flatly attached on an interface apparatus; (2) the interface apparatus, which can provide enough stiffness and be an interface for a robot arm to hold or unload, is easier to be processed than a glass substrate during operation; (3) the design of the interface apparatus, which can keep the first panel over the second panel a certain height without mounting the first panel on the upper press block, can simplify the mechanisms in the assembly room and shorten the cycle time; and (4) the action of rapidly releasing static electricity suckers can be prevented during the assembly processes in the assembly room because of the usage of the interface apparatus, such that the alignment error caused by nonsynchronization of releasing static electricity suckers can be reduced.

### SUMMARY OF THE INVENTION

A scope of the invention is to provide a method of assembling an LCD panel. Firstly, the method of assembling an LCD panel according to the invention is performed to mount a first panel on an interface apparatus, to form a first panel assembly. Then, the method of assembling an LCD panel according to the invention is performed to input a second panel and the first panel assembly into an assembly room. Next, the method of assembling an LCD panel according to the invention is performed to mount the second panel on a lower press block. Afterward, the method of assembling an LCD panel according to the invention is performed to support the interface apparatus, to keep the first panel over the second panel. Subsequently, the method of assembling an LCD panel according to the invention is performed to press the first panel to the second panel. Then, the method of assembling an LCD panel according to the invention is performed to output the first panel assembly which is pressed with the second panel from the assembly room. Finally, the method of assembling an LCD panel according to the invention is performed to separate the first panel from the interface apparatus.

Another scope of the invention is to provide an interface apparatus. The interface apparatus can be used to assemble a first panel and a second panel in an assembly room. The second panel is mounted in the assembly room. The interface apparatus includes a panel-mounting interface and an actuating interface. The panel-mounting interface can be used to mount the first panel. The actuating interface can be used to bear an external force to make the interface apparatus move relative to the second panel.

Another scope of the invention is to provide an assembling apparatus. The assembling apparatus can be used to assemble a first panel and a second panel. The assembling apparatus mainly includes an assembly room and a lower press block. The assembly room includes a panel actuating device and an air pressure control device. The air pressure control device can be used to control the air pressure in the assembly room. The lower press block is disposed in the assembly room. The lower press block includes a panel-mounting interface and an adjusting device. The panel-mounting interface can be used to mount the second panel. The adjusting device can be used to adjust the position of the second panel. Wherein, the panel actuating device makes the first panel move relative to the second panel to press the first panel with the second panel mounted on the lower press block.

Accordingly, the method of assembling an LCD panel, the interface apparatus, and the assembling apparatus according to the invention can achieve the advantages of simplifying the complexity of the assembly room, shortening the cycle time in the assembly room, and flatly attaching the panel on the interface apparatus with the assistance of the gravity of the panel.

The advantage and spirit of the invention may be understood by the following recitations together with the appended drawings.

### BRIEF DESCRIPTION OF THE APPENDED DRAWINGS

FIG. 1 is a flow chart showing the method of assembling an LCD panel according to the invention.

FIG. 2 is a side view illustrating the interface apparatus according to the invention.

FIG. 3A to FIG. 3K are schematic diagrams illustrating the method of assembling an LCD panel while assembling according to a first embodiment of the invention.

FIG. 4A and FIG. 4B are side views illustrating the interface apparatus according to the first embodiment of the invention.

FIG. 5 is a schematic diagram illustrating the method of assembling an LCD panel while assembling according to a fourth embodiment of the invention.

FIG. 6 is a side view illustrating the interface apparatus according to the fourth embodiment of the invention.

FIG. 7 is a schematic diagram illustrating the method of assembling an LCD panel while assembling according to a fifth embodiment of the invention.

FIG. 8 is a side view illustrating the interface apparatus according to the fifth embodiment of the invention.

FIG. 9 is a schematic diagram illustrating the method of assembling an LCD panel while assembling according to a sixth embodiment of the invention.

FIG. 10 is a side view illustrating the interface apparatus according to the sixth embodiment of the invention.

FIG. 11 is a side view illustrating the interface apparatus according to a seventh embodiment of the invention.

FIG. 12A is a cross-sectional view illustrating that the interface apparatus according to a ninth embodiment of the invention is operated in the assembling apparatus, wherein the assembling apparatus has not been pressed yet.

FIG. 12B is a cross-sectional view illustrating that the interface apparatus in FIG. 12A is operated in the assembling apparatus, wherein the assembling apparatus has been pressed.

FIG. 13A is a cross-sectional view illustrating that the interface apparatus according to a tenth embodiment of the invention is operated in the assembling apparatus, wherein the assembling apparatus has not been pressed yet.

FIG. 13B is a cross-sectional view illustrating that the interface apparatus in FIG. 13A is operated in the assembling apparatus, wherein the assembling apparatus has been pressed.

FIG. 13C is a cross-sectional view illustrating that the interface apparatus is operated in the assembling apparatus according to another embodiment.

FIG. 14 is a flow chart showing the method of assembling an LCD panel according to the ninth embodiment of the invention.

FIG. 15 is a flow chart showing the method of assembling an LCD panel according to the tenth embodiment of the invention.

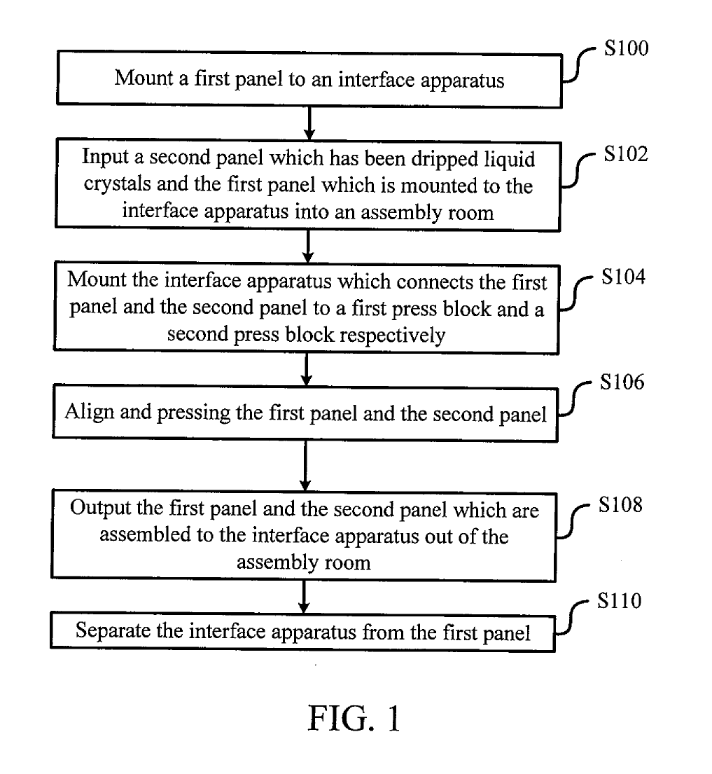

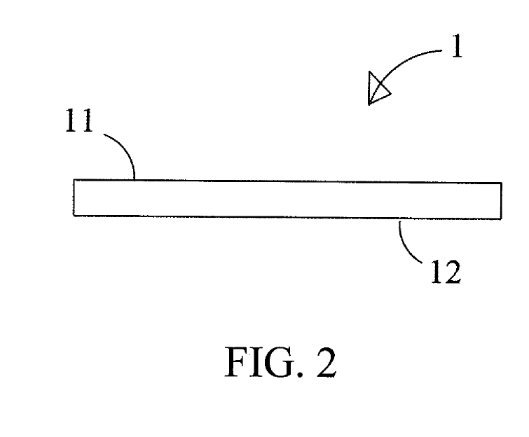

### DETAILED DESCRIPTION OF THE INVENTION

The purpose of the invention is to provide a method of assembling an LCD panel, an interface apparatus, and an assembling apparatus which can achieve the advantages of simplifying the complexity of the assembly room, shortening the cycle time in the assembly room, and flatly attaching the panel on the interface apparatus with the assistance of the gravity of the panel. The preferred embodiments of the invention are described below to illustrate the features and spirits of the invention.

The method of assembling an LCD panel includes following steps:

Step S100: mounting a first panel to an interface apparatus;

Step S102: inputting a second panel which has been dripped liquid crystal and the first panel which is mounted to the interface apparatus into an assembly room;

Step S104: mounting the interface apparatus which connects the first panel and the second panel to a first press block and a second press block respectively;

Step S106: aligning and pressing the first panel and the second panel;

Step S108: outputting the first panel and the second panel which are assembled to the interface apparatus out of the assembly room; and

Step S110: separating the interface apparatus from the first panel.

Wherein, the mounting approach in step S100 can be performed with main approaches such as adhering or static electricity attaching or auxiliary approaches such as vacuum attaching or mechanical holding. The main approach of adhering is performed to make the first panel and the interface apparatus adhere to each other with an adhesion layer, and the adhesion layer is elastic. The adhesion layer can be a thermal separation film and/or a radial separation film. The main approach of static electricity attaching is performed to place an elastic layer between the first panel and the interface apparatus. In the main approach of static electricity attaching, the interface apparatus is powered by an external power supply to make the interface apparatus and the first panel attach to each other. After the interface apparatus is inputted in the assembly room and mounted to the first press block, the interface apparatus can be powered by the first press block, and the external power supply can be shut down, to make the interface apparatus and the first panel static electricity attach to each other. Wherein, step S100 further includes the step of disposing a sealant to the first panel.

Step S102 further includes the step of disposing a sealant to the second panel.

Step S104 which is performed to mounting the interface apparatus to the first press block is achieved by the approaches such as static electricity attaching, electromagnetic attaching, locking, or mechanical holding.

Step S106 further includes the step of lowering the air pressure in the assembly room, the step of approaching the first panel to the second panel gradually and pressing, and the step of separating the first press block from the interface apparatus after the sealant is temporarily hardened and the air pressure returns to the atmosphere. Another workable approach is that step S106 further includes the precisely aligning step of approaching the first panel to the second panel up to a tiny distance (such as 100˜200 μm) gradually, and the step of precisely aligning further includes the step of releasing the attachment the first press block applies to the interface apparatus to separate the interface apparatus from the first press block. The step of releasing the attachment the attachment the first press block applies to the interface apparatus which can also include the step of applying a force (such as a reverse magnetic force, an air force, or an elastic force) from the first press block to the interface apparatus to separate the interface apparatus from the first press block. The step of releasing the attachment to the interface apparatus to separate the interface apparatus from the first press block further includes the steps of returning the air pressure to the atmosphere after temporarily hardening the sealant.

Step S108 further includes the step of releasing the viscosity of the adhesion layer between the first panel and the interface apparatus with a heating step, the step of releasing the static electrical attachment between the first panel and the interface apparatus, or the step of releasing the vacuum attachment or mechanical holding between the first panel and the interface apparatus. Step S108 can also include the step of permanently hardening the sealant.

The interface apparatus according to the invention includes: a main body 1 of the interface apparatus; a panel interface 11 which is disposed at one side of the main body 1 of the interface apparatus; and a first press block interface 12 which is disposed at another side of the main body 1 of the interface apparatus. Wherein, an adhesion layer is disposed to the panel interface 11. The adhesion layer can be a thermal separation film and/or a radial separation film. Or, a main device such as a static electricity attaching device, a vacuum attachment device or an auxiliary device such as a mechanical holding device can be disposed to the panel interface 11, and an elastic layer is further disposed to the panel interface 11. Wherein, the first press block interface 12 has magnetoconductivity, or a magnetic device, a static electrical attachment interface, at least locker, a locking interface, a holding mechanism, or a mechanical holding interface is disposed to the first press block interface 12.

### First Embodiment

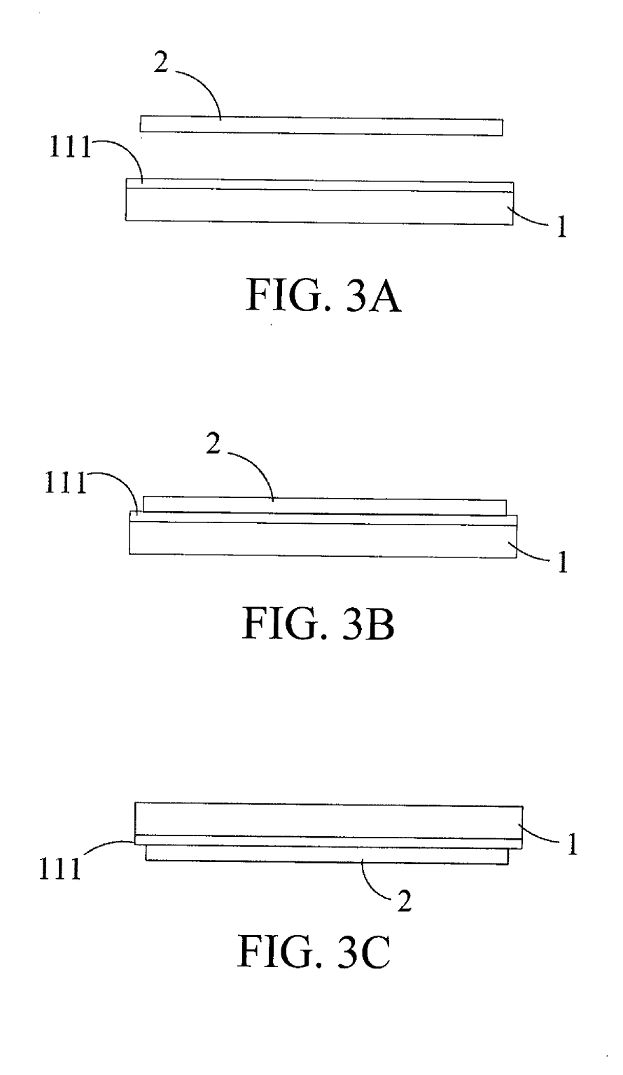

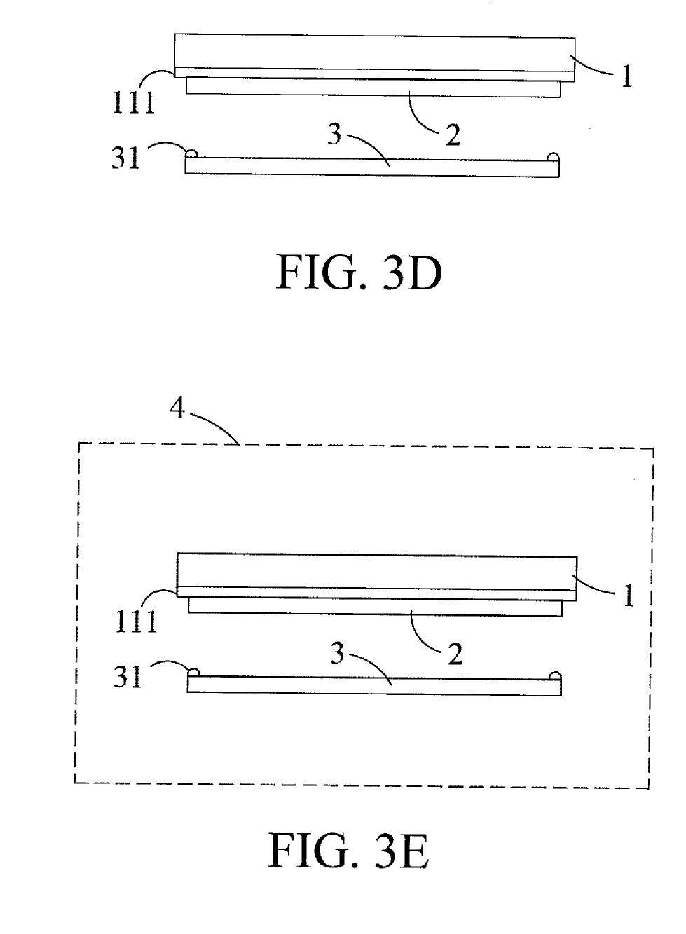

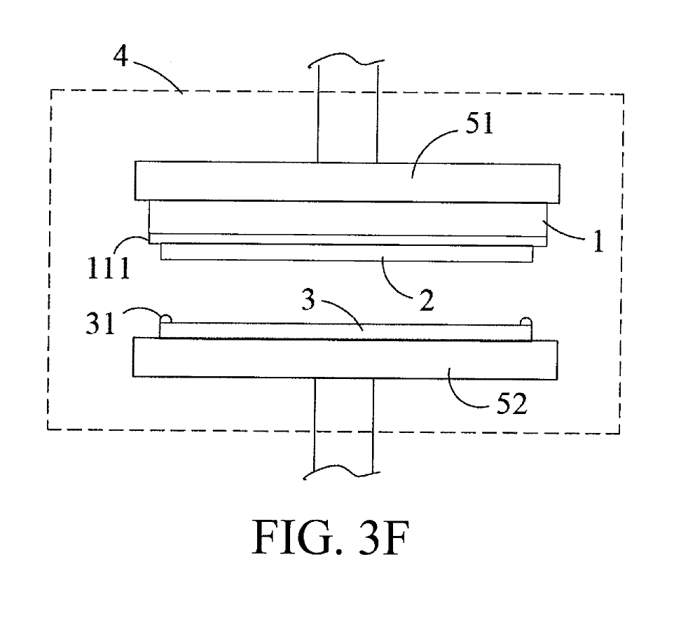

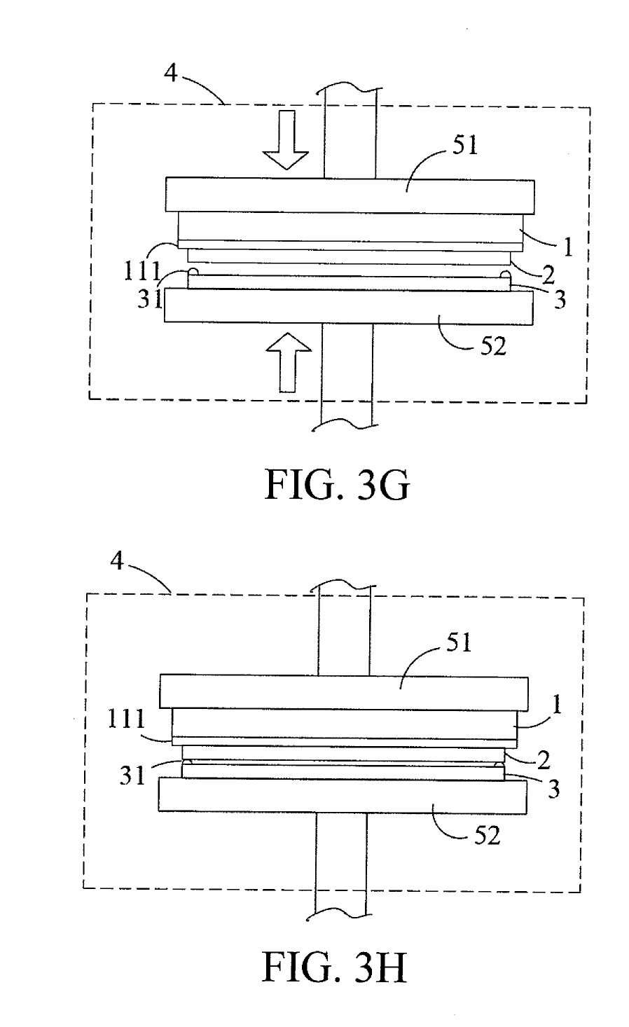

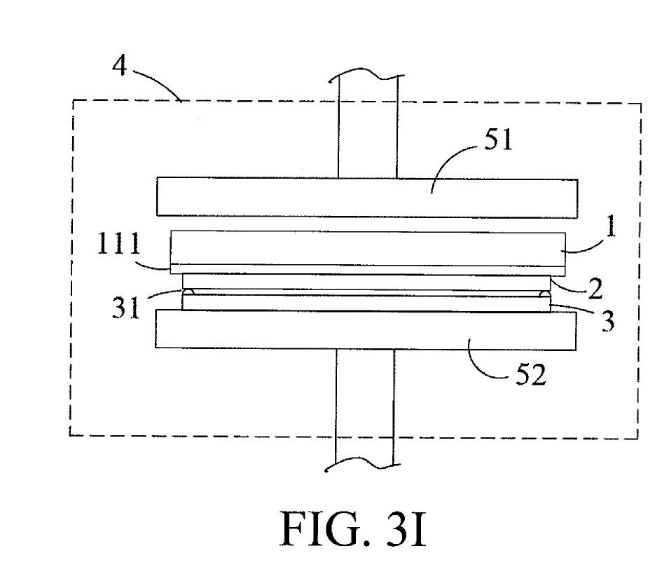

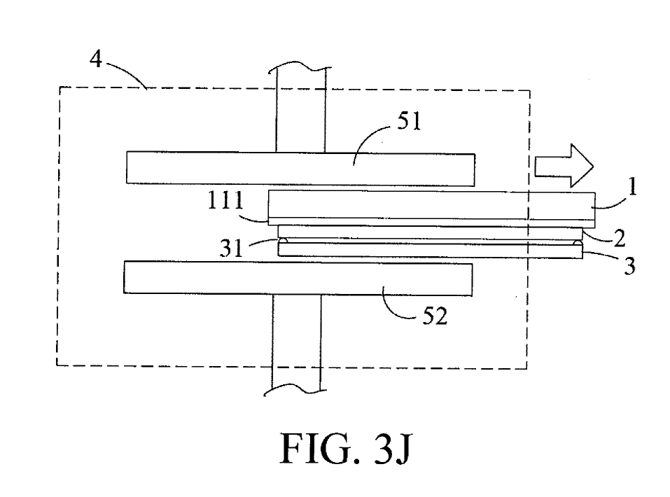

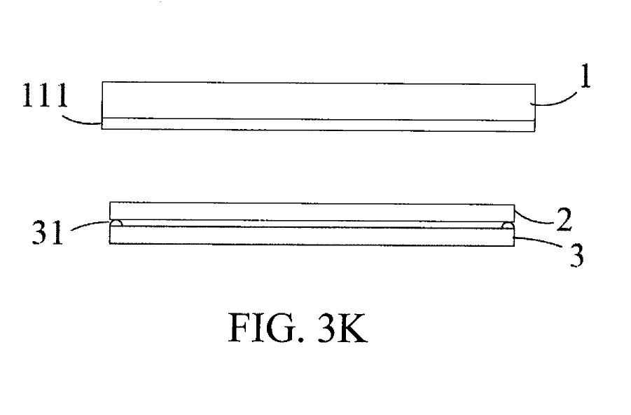

The method of assembling an LCD panel is performed by the following steps:
(1) adhering the first panel 2 on the main body 1 of the interface apparatus with a thermal separation film 111 which is elastic before entering the vacuum assembly room and then turning the first panel 2 over, as shown in FIG. 3A to FIG. 3C;
(2) transporting (simultaneously or one by one) the second panel 3 which has been applied sealant 31 and dripped liquid crystal and the first panel 2 which is mounted to the main body 1 of the interface apparatus into a vacuum assembly room 4, as shown in FIG. 3D to FIG. 3E; (Meanwhile, because the interface apparatus can provide enough stiffness, it is easier to be operated than a glass substrate and can solve the problems of inputting, carrying, and flatly attaching caused by the much bigger panel after the 8^{th} generation.)
(3) mounting the second panel 3 to the second press block 52 with a traditional approach, and electromagnetically attaching the main body 1 of the interface apparatus connected with the first panel 2 by the first press block 51, as shown in FIG. 3F.
(4) vacuuming and aligning are performed, approaching the first panel 2 to the second panel 3 to align and to be pressed, temporarily hardening the sealant 31, and then returning the air pressure to the atmosphere, as shown in FIG. 3G to FIG. 3H; moreover, releasing the electromagnetic attachment the first press block 51 applies to the main body 1 of the interface apparatus, as shown in FIG. 3I.
(5) outputting the first panel 1 and the second panel 3 which are mounted to the main body 1 of the interface apparatus after assembling out of the assembly room 4, as shown in FIG. 3J; and
(6) heating the sealant 31 to be hardened and separating the main body 1 of the interface apparatus from the first panel 2 of the assembled first panel 2 and the second panel 3 (because the viscosity of the thermal separation film 111 will disappear after being heated to a certain temperature), as shown in FIG. 3K.

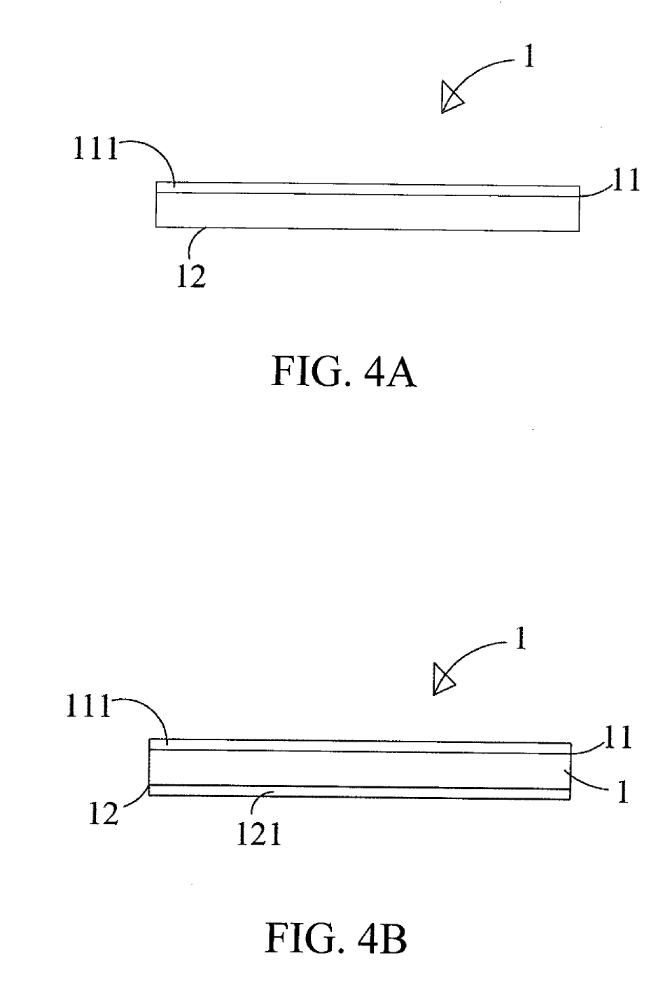

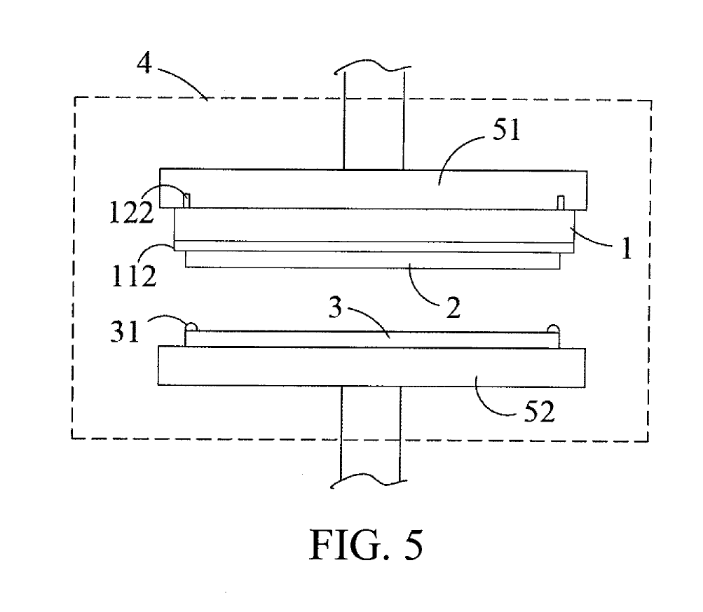

The first embodiment of the interface apparatus includes (as shown in FIG. 4A and FIG. 4B): an main body 1 of the interface apparatus; a panel interface 11 which is disposed at one side of the main body 1 of the interface apparatus; and a first press block interface 12 which is disposed at another side of the main body 1 of the interface apparatus. Wherein, a thermal separation film 111 is disposed to the panel interface 11. Wherein, the first press block interface 12 has magnetoconductivity, or a magnetic device 121 is disposed to the first press block interface 12.

### Second Embodiment

The difference between the second embodiment and the first embodiment of the method of assembling an LCD panel is that step (4) can be changed as: releasing the electromagnetic attachment the first press block 51 applies to the main body 1 of the interface apparatus or further applying a reverse magnetic force after approaching the first panel 2 to the second panel 3 up to a tiny distance (such as 100˜200 μm) gradually, so as to separate the main body 1 of the interface apparatus from the first press block 51, to attach the first panel 2 to the second panel 3, to temporarily harden the sealant 31, and then to return the air pressure to the atmosphere.

### Third Embodiment

The difference between the third embodiment and the first embodiment of the method of assembling an LCD panel is that the step of applying and releasing the electromagnetic attachment in step (3) can be changed as applying and releasing an static electrical attachment, wherein the first press block interface 12 of the interface apparatus can be static electrically attached.

### Fourth Embodiment

The difference between the fourth embodiment and the first embodiment of the method of assembling an LCD panel is that step (1) can be changed as: static electrically attaching the first panel 2 with the main body 1 of the interface apparatus and then turning over before the first panel 2 enters the vacuum assembly room 4. Step (3) can be changed as: mounting the second panel 2 to the second press block 52 with a traditional approach, and mounting the main body 1 of the interface apparatus which is connected with the first panel 2 to the first press block 51 with a locker 122. Step (4) can be changed as: vacuuming, aligning, approaching the first panel 2 to the second panel 3 gradually, and separating the locker 122 on the interface apparatus from the first press block 51 after aligning, pressing, hardening the sealant, and returning the air pressure to the atmosphere. Besides the step of permanently hardening the sealant, step (6) can be changed as: releasing the static electrical attachment between the first panel and the interface apparatus, to separate the main body 1 of the interface apparatus from the first panel 2 of the assembled first panel 2 and the second panel 3.

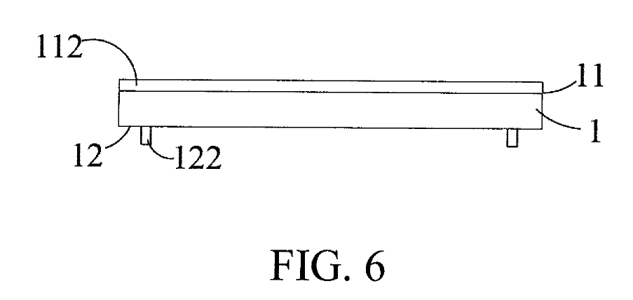

As shown in FIG. 6, the difference between the fourth embodiment and the first embodiment of the interface apparatus is that a static electricity attaching device 112 is disposed to the panel interface 11 in the fourth embodiment, and at least one locker 122 is disposed to the first press block interface 12.

### Fifth Embodiment

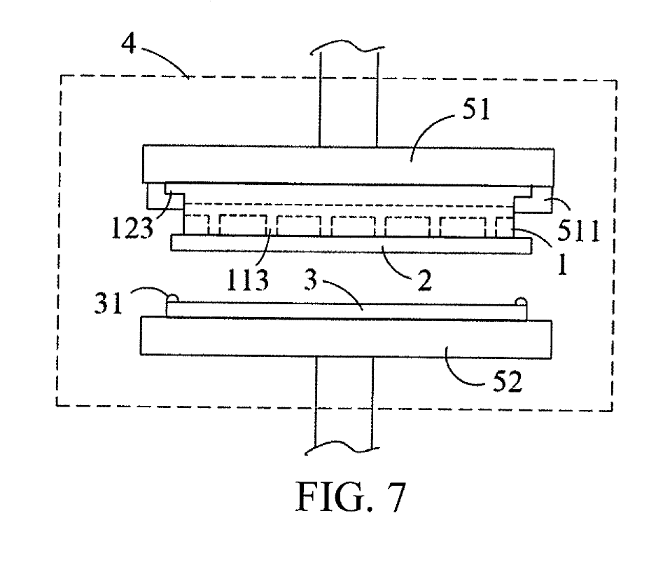

The difference between the fifth embodiment and the first embodiment of the method of assembling an LCD panel is that step (1) can be changed as: attaching the first panel 2 to the main body 1 of the interface apparatus with a main approach of static electrically attaching and an auxiliary approach of vacuum attaching and then turning over before the first panel 2 enters the vacuum assembly room 4. The auxiliary approach of vacuum attaching can be removed from any of the subsequent steps if necessary, and step (3) can be changed as: mounting the second panel 3 to the second press block 52 with a traditional approach and mounting the main body 1 of the interface apparatus which is connected with the first panel 2 to the first press block 51 with a holding mechanism 511, as shown in FIG. 7. Step (4) can be changed as: vacuuming, aligning, approaching the first panel 2 to the second panel 3 gradually, and releasing the holding mechanism 511 to separate the interface apparatus from the first press block 51 after aligning, pressing, hardening the sealant, and returning the air pressure to the atmosphere. Besides the step of permanently hardening the sealant, step (6) can be changed as: releasing the static electrical attachment and the vacuum attachment between the first panel and the main body 1 of the interface apparatus, to separate the main body 1 of the interface apparatus from the first panel 2 of the assembled first panel 2 and the second panel 3.

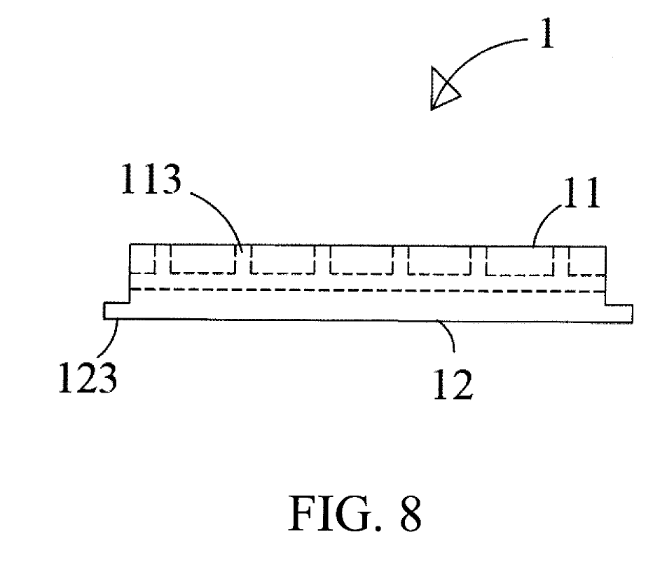

As shown in FIG. 8, the difference between the fifth embodiment and the first embodiment of the interface apparatus is that the panel interface 11 is a static electrical attaching interface in the fifth embodiment, a vacuum attaching device 113 is disposed to the static electrical attaching interface, and a mechanical holding interface 123 which can be held by the holding mechanism 511 is disposed to the first press block interface 12.

### Sixth Embodiment

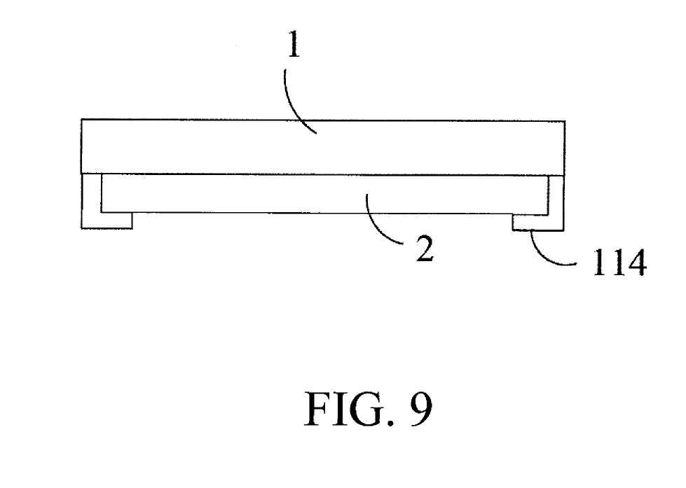

The difference between the sixth embodiment and the first embodiment of the method of assembling an LCD panel is that step (1) can be changed as: attaching the first panel 2 to the main body 1 of the interface apparatus with a main approach of static electrically attaching and an auxiliary approach of mechanically holding and then turning over before the first panel 2 enters the vacuum assembly room 4 (as shown in FIG. 9). The auxiliary approach of mechanically holding can be removed from any of the subsequent steps if necessary. Step (6) can be changed as: releasing the static electrical attachment between the first panel and the main body 1 of the interface apparatus, to separate the main body 1 of the interface apparatus from the first panel 2 of the assembled first panel 2 and the second panel 3.

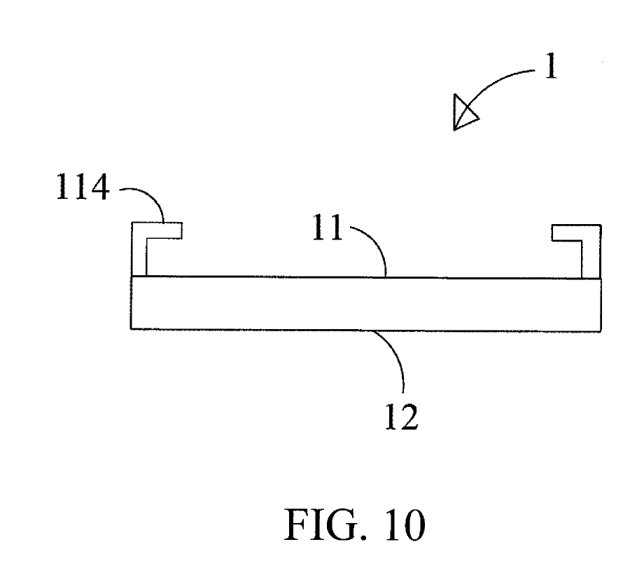

As shown in FIG. 10, the difference between the sixth embodiment and the first embodiment of the interface apparatus is that the panel interface 11 is a static electrical attaching interface in the fifth embodiment and a holding mechanism 114 is disposed to the static electrical attaching interface.

### Seventh Embodiment

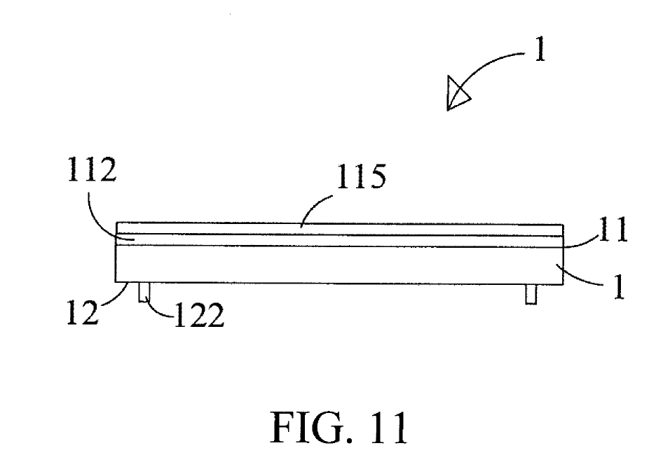

As shown in FIG. 11, the difference between the seventh embodiment and the forth embodiment of the interface apparatus is that the static electricity attaching device 112 of the seventh embodiment is further connected with an elastic layer 115. When the static electricity interface attaches the first panel 2, the elastic layer 115 can make the first panel 2 and the second panel 3 level and parallel to each other.

### Eighth Embodiment

The difference between the eighth embodiment and the first embodiment of the method of assembling an LCD panel is that in the eighth embodiment, the second panel is attached to another interface apparatus without turning over, and the second panel is electromagnetically attached to the second press block and then is pressed with the first panel.

### Nine Embodiment

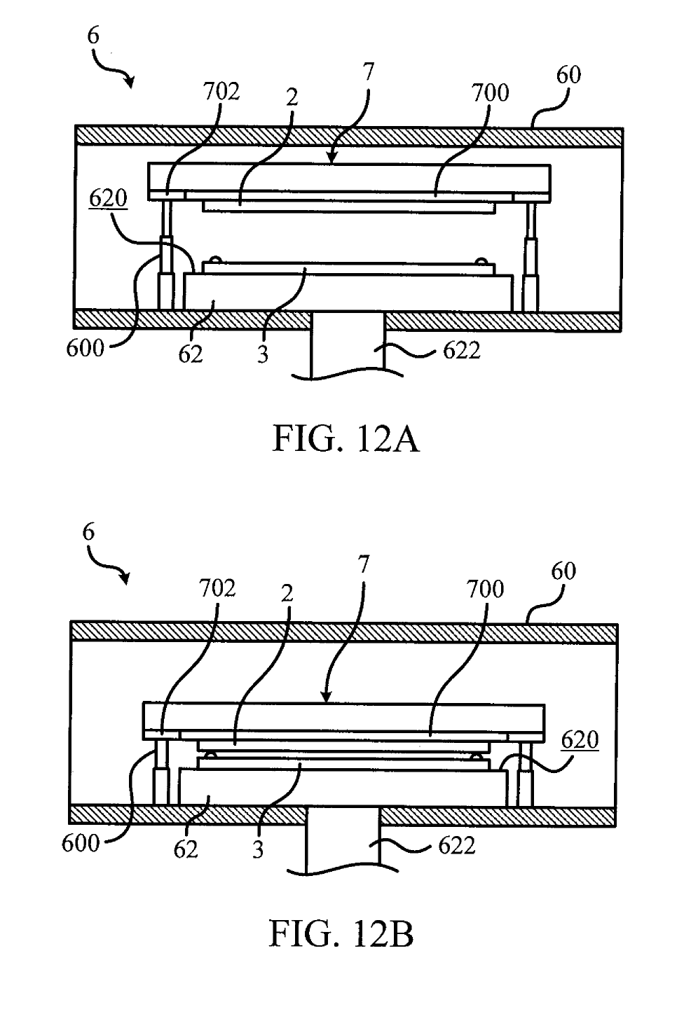

Please refer to FIGS. 12A and 12B. FIG. 12A is a cross-sectional view illustrating that the interface apparatus 7 according to a ninth embodiment of the invention is operated in the assembling apparatus 6, wherein the assembling apparatus 6 has not been pressed yet. FIG. 12B is a cross-sectional view illustrating that the interface apparatus 7 in FIG. 12A is operated in the assembling apparatus 6, wherein the assembling apparatus 6 has been pressed. The ninth embodiments of the invention are described below to illustrate the features and spirits of the invention.

As shown in FIG. 12A, the assembling apparatus 6 and the interface apparatus 7 are used to assemble the first panel 2 and the second panel 3. The assembling apparatus 6 includes an assembly room 60 and a lower press block 62. The assembly room 60 includes a linear motion device 600 and an air pressure control device (not shown). The air pressure control device can be used to control the air pressure in the assembly room 60. The lower press block 62 is disposed in the assembly room 60. The lower press block 62 includes a panel-mounting interface 620 and an adjusting device 622. The panel-mounting interface 620 can be used to mount the second panel 3. The adjusting device 622 can be used to adjust the position of the second panel 3.

As shown in FIG. 12A, the interface apparatus 7 is mainly used to assemble the first panel 2 and the second panel 3 in the assembly room 60 of the assembling apparatus 6. The interface apparatus 7 includes a panel-mounting interface 700 and an actuating interface 702. The panel-mounting interface 700 can be used to mount the first panel 2. The actuating interface 702 can serve as a carrying interface of a transportation device (not shown) to make the interface apparatus 7 get in and out of the assembly room 60 and bear an external force to make the interface apparatus 7 moves relative to the second panel 3. In the ninth embodiment, the external force is generated by the linear motion device 600. Thereby, the external force generated by the linear motion device 600 can make the interface apparatus 7 which is mounted with the first panel 2 move relative to the second panel 3 which is mounted to the panel-mounting interface 620, to press the first panel 2 to the second panel 3 with the lower press block 62, as shown in FIG. 12B.

In an embodiment, to flatly attach the first panel 2 to the interface apparatus 7, the panel-mounting interface 700 of the interface apparatus 7 can have a static electrical attaching device (not shown). In another workable embodiment, the panel-mounting interface 700 of the interface apparatus 7 can also have an adhesion layer (not shown). Of course, the panel-mounting interface 700 of the interface apparatus 7 can also have an elastic layer (not shown). The first panel 2 can be attached to the panel-mounting interface 700 of the interface apparatus 7 by using the thermal separation film of the elastic layer.

### Tenth Embodiment

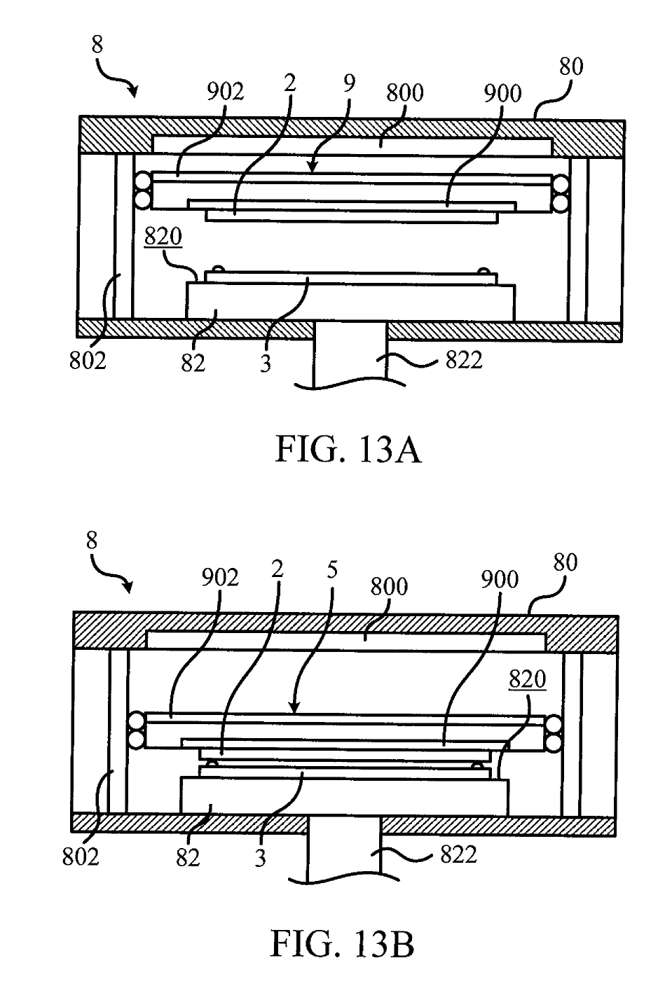

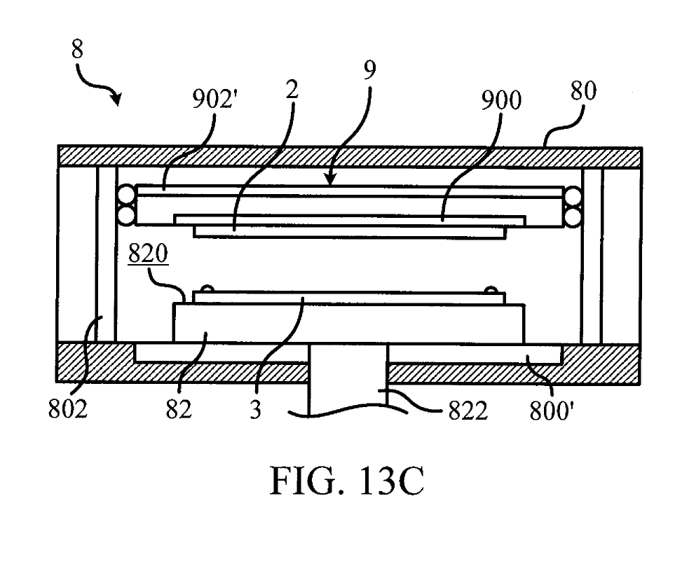

Please refer to FIG. 13A and FIG. 13B, FIG. 13A is a cross-sectional view illustrating that the interface apparatus 9 according to a tenth embodiment of the invention is operated in the assembling apparatus 8, wherein the assembling apparatus 8 has not been pressed yet. FIG. 13B is a cross-sectional view illustrating that the interface apparatus 9 in FIG. 13A is operated in the assembling apparatus 8, wherein the assembling apparatus 8 has been pressed. The tenth embodiments of the invention are described below to illustrate the features and spirits of the invention.

As shown in FIG. 13A, the assembling apparatus 8 and the interface apparatus 9 are used to assemble the first panel 2 and the second panel 3. The assembling apparatus 8 includes an assembly room 80 and a lower press block 82. The assembly room 80 includes an electromagnetic device 800 and an air pressure control device (not shown). The air pressure control device can be used to control the air pressure in the assembly room 80. The lower press block 82 is disposed in the assembly room 80. The lower press block 82 includes a panel-mounting interface 820 and an adjusting device 822. The panel-mounting interface 820 can be used to mount the second panel 3. The adjusting device 822 can be used to adjust the position of the second panel 3.

As shown in FIG. 13A, the interface apparatus 9 is mainly used to assemble the first panel 2 and the second panel 3 in the assembly room 80 of the assembling apparatus 8. The interface apparatus 9 includes a panel-mounting interface 900 and an actuating interface 902. The panel-mounting interface 900 can be used to mount the first panel 2. The actuating interface 902 can serve as a carrying interface of a transportation device (not shown) to make the interface apparatus 9 get in and out of the assembly room 80 and bear an external force to make the interface apparatus 9 move relative to the second panel 3. In the tenth embodiment, the external force is generated by the electromagnetic device 800. Thereby, the magnetic force generated by the electromagnetic device 800 can make the interface apparatus 9 which is mounted with the first panel 2 move relative to the second panel 3 which is mounted to the panel-mounting interface 820, so as to press the first panel 2 to the second panel 3 with the lower press block 82, as shown in FIG. 13B.

It is notable that to keep the level of the first panel 2 and prevent the existence of the lateral displacement of the first panel 2 during the period the first panel 2 which is mounted with the interface apparatus 9 presses toward the second panel 3 which is mounted to the lower press block 82, the assembly room 80 can farther include a guiding device 802. Thereby, the first panel 2 can be guided during the period the first panel 2 moves relative to the second panel 3.

Moreover, in the embodiment, the interface apparatus 9 is disposed between the electromagnetic device 800 and the lower press block 82, as shown in FIG. 13A. Therefore, while willing to keep the first panel 2 over the second panel 3 a certain distance, the electromagnetic device 800 can apply the magnetic force to the actuating interface 902 of the interface apparatus 9 to make the interface apparatus 9 which is mounted with the first panel 2 be suspended over the second panel 3; while willing to press the first panel 2 and the second panel 3, the electromagnetic device 800 can release the magnetic force or generate an additional reverse magnetic force together with the gravity forces of the interface apparatus 9 and the first panel 2 to press the first panel 2 to the second panel 3.

### Eleventh Embodiment

Please refer to FIG. 13C. FIG. 13C is a cross-sectional view illustrating that the interface apparatus 9 is operated in the assembling apparatus 8 according to another embodiment. As shown in FIG. 13C, the lower press block 82 can be disposed between an electromagnetic device 800′ and the interface apparatus 9. Therefore, while willing to keep the first panel 2 over the second panel 3 a certain distance, the electromagnetic device 800′ can apply a magnetic repulsive force to the actuating interface 902′ of the interface apparatus 9 to make the interface apparatus 9 which is mounted with the first panel 2 be suspended over the second panel 3; while willing to press the first panel 2 and the second panel 3, the electromagnetic device 800′ can release the magnetic repulsive force or generate an additional magnetic attraction force together with the gravity forces of the interface apparatus 9 and the first panel 2 to press the first panel 2 to the second panel 3.

### Twelfth Embodiment

Furthermore, taking FIG. 13A as the infrastructure of another workable embodiment, the actuating interface 902 is completely attached to the electromagnetic device 800 of the assembly room 80 and over the second panel 3. During aligning, the relative position of the second panel 3 to the first panel 2 can be controlled by the actions such as horizontal moving, rotating, lifting, or descending performed by the adjusting device 822. During the period the first panel 2 presses toward the second panel 3 (the gap is smaller than 100 μm), the adjusting device 822 can make the lower press block 82 move toward the first panel 2, to press the second panel 3 to the first panel 2. Or, it can also be achieved by releasing the attraction force or generating an additional repulsive force by the electromagnetic device 800.

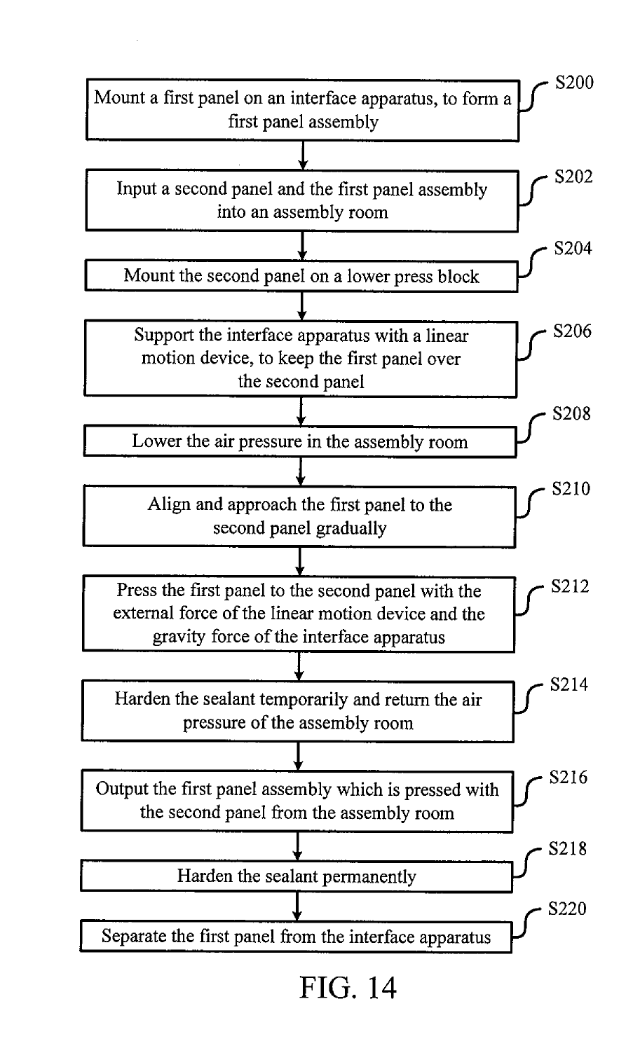

Please refer to FIG. 14 together with FIG. 12A and FIG. 12B. FIG. 14 is a flow chart showing the method of assembling an LCD panel according to the ninth embodiment of the invention. The method of assembling an LCD panel according to the ninth embodiment of the invention mainly includes following steps.

As shown in FIG. 14, the method of assembling an LCD panel according to the ninth embodiment of the invention firstly includes step S200: mounting a first panel 2 on an interface apparatus 7, to form a first panel assembly. In a practical application, the first panel 2 can be mounted to the interface apparatus 7 by applying an adhesion process or a static electrical attaching process. Moreover, the first panel 2 can also be mounted to the interface apparatus 7 by applying a mechanical holding process or a vacuum attaching process. Additionally, an elastomer (not shown) can be disposed between the first panel 2 and the interface apparatus 7. Moreover, a process of applying sealant can be added before or after the first panel 2 is mounted with the interface apparatus 7 in the step.

Then, the method of assembling an LCD panel according to the ninth embodiment of the invention includes step S202: inputting a second panel 3 and the first panel assembly (i.e., the first panel 2 and the interface apparatus 7 which are mounted to each other) into an assembly room 60. Wherein, processes of disposing sealant and dripping liquid crystals are performed to the second panel 3.

Next, the method of assembling an LCD panel according to the ninth embodiment of the invention includes step S204: mounting the second panel 3 on a lower press block 62. It is notable that the step of inputting the second panel 3 into the assembly room 60 and mounting the second panel 3 to the lower press block 22 are unnecessary to comply with steps S200˜S204. In other words, the step of inputting the second panel 3 into the assembly room 60 and mounting the second panel 3 to the lower press block 22 can be performed before the step of inputting the interface apparatus 7 which is mounted with the first panel 2 into the assembly room 60.

As shown in FIG. 12A and FIG. 14, after inputting the interface apparatus 7 which is mounted with the first panel 2 into the assembly room 60, the method of assembling an LCD panel according to the ninth embodiment of the invention includes step S206: supporting the interface apparatus 7 with a linear motion device 600, to keep the first panel 2 over the second panel 3. Subsequently, the method of assembling an LCD panel according to the ninth embodiment of the invention includes step S208: lowering the air pressure in the assembly room 60. Then, the method of assembling an LCD panel according to the ninth embodiment of the invention includes step S210: aligning and approaching the first panel 2 to the second panel 3 gradually.

As shown in FIG. 12B and FIG. 14, after aligning and approaching the first panel 2 to the second panel 3 gradually, the method of assembling an LCD panel according to the ninth embodiment of the invention includes step S212: pressing the first panel 2 to the second panel 3 with the external force of the linear motion device 600 and the gravity force of the interface apparatus 7. It is notable that the linear motion device 600 provides a supporting force which is equal to the gravity forces of the interface apparatus 7 and the first panel 2 when the linear motion device 600 supports the interface apparatus 7 to keep the first panel 2 over the second panel 3. While willing to press the first panel 2 to the second panel 3, the linear motion device 600 can release the supporting force and press the first panel 2 to the second panel 3 only with the gravity forces of the interface apparatus 7 and the first panel 2; or the linear motion device 600 can further provide a reverse supporting force together with the gravity forces of the interface apparatus 7 and the first panel 2 to press the first panel 2 to the second panel 3.

As shown in FIG. 14, the method of assembling an LCD panel according to the ninth embodiment of the invention includes step S214: hardening the sealant temporarily and returning the air pressure of the assembly room 60. After that, the method of assembling an LCD panel according to the ninth embodiment of the invention includes step S216: outputting the first panel assembly which is pressed with the second panel 3 from the assembly room 60. Meanwhile, both the first panel 2 and the second panel 3 are mounted to the interface apparatus 7. Furthermore, the method of assembling an LCD panel according to the ninth embodiment of the invention includes step S218: hardening the sealant permanently. Finally, the method of assembling an LCD panel according to the ninth embodiment of the invention includes step S220: separating the first panel 2 from the interface apparatus 7. It is notable that the step S218 can also be performed after the step S220 without being limited by the flow chart in FIG. 14 if necessary. Thereby, the method of assembling an LCD panel according to the ninth embodiment of the invention can be accomplished to assemble the first panel 2 and the second panel 3.

It is notable that if a process of adhesion is performed in step S200, the method of assembling an LCD panel according to the ninth embodiment of the invention includes step S222: lowering the viscosity between the interface apparatus 7 and the first panel 2 (not shown in FIG. 14). Similarly, if a process of static electrical attaching is performed in step S200, the method of assembling an LCD panel according to the ninth embodiment of the invention includes step S224: removing the static electricity between the interface apparatus 7 and the first panel 2 (not shown in FIG. 14).

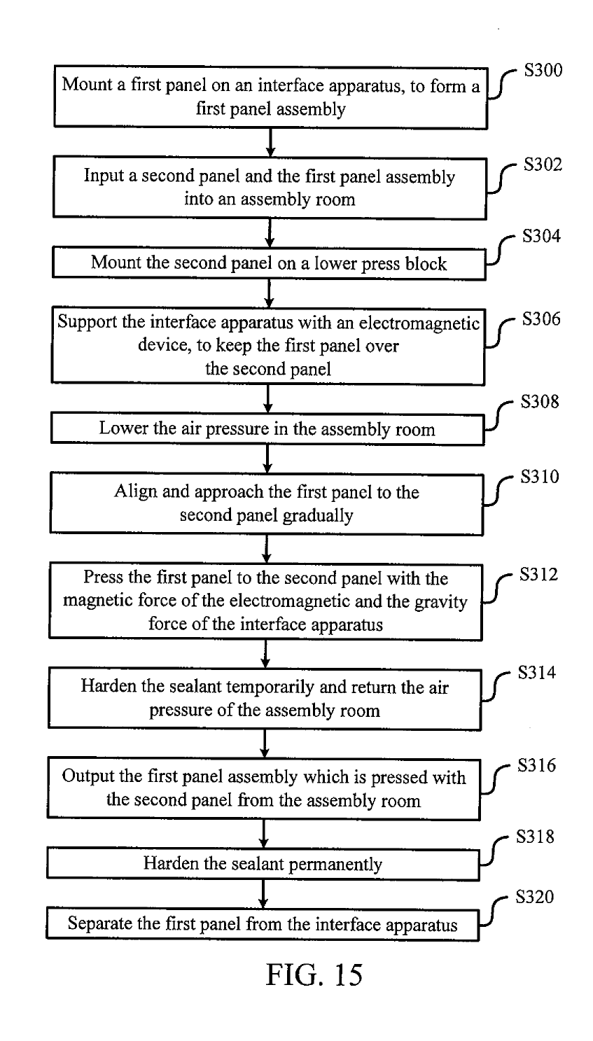

Please refer to FIG. 15 together with FIG. 13A and FIG. 13B, FIG. 15 is a flow chart showing the method of assembling an LCD panel according to the tenth embodiment of the invention. The tenth embodiments of the invention are described below to illustrate the features and spirits of the invention.

As shown in FIG. 15, the method of assembling an LCD panel according to the tenth embodiment of the invention firstly includes step S300: mounting a first panel 2 on an interface apparatus 9, to form a first panel assembly. The method of assembling an LCD panel according to the tenth embodiment of the invention firstly includes step S302: inputting a second panel 3 and the first panel assembly into an assembly room 80. Wherein, processes of disposing sealant and dripping liquid crystals are performed to the second panel 3. The method of assembling an LCD panel according to the tenth embodiment of the invention firstly includes step S304: mounting the second panel 3 on a lower press block 82. Similarly, it is notable that the step of inputting the second panel 3 into the assembly room 80 and mounting the second panel 3 to the lower press block 82 can be performed before the step of inputting the interface apparatus 9 which is mounted with the first panel 2 into the assembly room 80.

As shown in FIG. 13A and FIG. 15, after inputting the interface apparatus 9 which is mounted with the first panel 2 into the assembly room 80, the method of assembling an LCD panel according to the tenth embodiment of the invention includes step S306: supporting the interface apparatus 9 with an electromagnetic device 800, to keep the first panel 2 over the second panel 3. Subsequently, the method of assembling an LCD panel according to the tenth embodiment of the invention includes step S308: lowering the air pressure in the assembly room 80. Then, the method of assembling an LCD panel according to the tenth embodiment of the invention includes step S310: aligning and approaching the first panel 2 to the second panel 3 gradually.

As shown in FIG. 13A and FIG. 15, after aligning and approaching the first panel 2 to the second panel 3 gradually, the method of assembling an LCD panel according to the tenth embodiment of the invention includes step S312: pressing the first panel 2 to the second panel 3 with the magnetic force of the electromagnetic device 800 and the gravity force of the interface apparatus 9. It is notable that the interface apparatus 9 can be disposed between the electromagnetic device 800 and the lower press block 82, as shown in FIG. 13A. In other words, the electromagnetic device 800 provides a magnetic attraction force which is equal to the gravity forces of the interface apparatus 9 and the first panel 2 when the electromagnetic device 800 applies the magnetic attraction force to the interface apparatus 9 to keep the first panel 2 over the second panel 3. While willing to press the first panel 2 to the second panel 3, the electromagnetic device 800 can remove the magnetic attraction force and press the first panel 2 to the second panel 3 only with the gravity forces of the interface apparatus 9 and the first panel 2; or the electromagnetic device 800 can further applies a magnetic repulsive force together with the gravity forces of the interface apparatus 9 and the first panel 2 to press the first panel 2 to the second panel 3.

In a practical application, the lower press block 82 can also be disposed between the electromagnetic device 800′ and the interface apparatus 9, as shown in FIG. 13C. In other words, the electromagnetic device 800+ provides a magnetic repulsive force which is equal to the gravity forces of the interface apparatus 9 and the first panel 2 when the electromagnetic device 800′ applies the magnetic repulsive force to the interface apparatus 9 to keep the first panel 2 over the second panel 3. While willing to press the first panel 2 to the second panel 3, the electromagnetic device 800′ can remove the magnetic repulsive force and press the first panel 2 to the second panel 3 only with the gravity forces of the interface apparatus 9 and the first panel 2; or the electromagnetic device 800′ can further applies a magnetic attraction force together with the gravity forces of the interface apparatus 9 and the first panel 2 to press the first panel 2 to the second panel 3.

Moreover, taking FIG. 13A as the embodiment, if the actuating interface 902 is completely attached to the electromagnetic device 800 of the assembly room 80 and over the second panel 3 in step S310, the method of assembling an LCD panel according to the tenth embodiment of the invention includes step S312′: driving the adjusting device 822 to make the lower press block 82 move toward the first panel 2, to press the second panel 3 to the first panel 2 (not shown). By releasing the attraction force or generating an additional repulsive force by the electromagnetic device 800, this can also be achieved.

As shown in FIG. 15, the method of assembling an LCD panel according to the tenth embodiment of the invention includes step S314: hardening the sealant temporarily and returning the air pressure of the assembly room 80. After that, the method of assembling an LCD panel according to the tenth embodiment of the invention includes step S316: outputting the first panel assembly which is pressed with the second panel 3 from the assembly room 80. Meanwhile, both the first panel 2 and the second panel 3 are mounted to the interface apparatus 9. Furthermore, the method of assembling an LCD panel according to the tenth embodiment of the invention includes step S318: hardening the sealant permanently. Finally, the method of assembling an LCD panel according to the tenth embodiment of the invention includes step S320: separating the first panel 2 from the interface apparatus 9. It is notable that the step S318 can also be performed after the step S320 without being limited by the flow chart in FIG. 15 if necessary. Thereby, the method of assembling an LCD panel according to the tenth embodiment of the invention can be accomplished to assemble the first panel 2 and the second panel 3.

Similarly, if a process of adhesion is performed in step S300, the method of assembling an LCD panel according to the tenth embodiment of the invention includes step S322: lowering the viscosity between the interface apparatus 9 and the first panel 2 (not shown in FIG. 15). Additionally, if a process of static electrical attaching is performed in step S300, the method of assembling an LCD panel according to the ninth embodiment of the invention includes step S324: removing the static electricity between the interface apparatus 9 and the first panel 2 (not shown in FIG. 15).

With the foregoing detailed description of the preferred embodiments of the invention, it can be clearly known that with the method of assembling an LCD panel, the interface apparatus, and the assembling apparatus, the following benefits/advantages can be achieved: (1) the complexity of the assembly room can be simplified and the cycle time in the assembly room can be shortened by moving the processes of flatly attaching and separating panels out of the assembly room, and the gravity of the panel is helpful for the panel to be flatly attached on an interface apparatus; (2) the interface apparatus, which can provide enough stiffness and be an interface for a robot arm to hold or unload, is easier to be processed than a glass substrate during operation; (3) the design of the interface apparatus, which can keep the first panel over the second panel a certain height without mounting the first panel on the upper press block, can simplify the mechanisms in the assembly room and shorten the cycle time; and (4) because the upper press block is unnecessary and the interface apparatus is attaching the first panel while pressing downward, the alignment offset caused by the static electricity sucker which does not easy to release simultaneously after the 8^{th} generation.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as being limited only by the metes and bounds of the appended claims.

What is claimed is:

1. A method of assembling an LCD panel, comprising the steps of:
(a) mounting a first panel on an interface apparatus, to form a first panel assembly;
(b) inputting a second panel and the first panel assembly into an assembly room;
(c) mounting the second panel on a lower press block;
(d) supporting the interface apparatus, so as to keep the first panel over the second panel;
(e) pressing the first panel to the second panel;
(f) outputting the first panel assembly which is pressed with the second panel from the assembly room; and
(g) separating the first panel from the interface apparatus.

2. The method of assembling an LCD panel of claim 1, wherein the first panel is mounted on the interface apparatus by electrically attaching or adhering.

3. The method of assembling an LCD panel of claim 2, wherein the first panel is mounted on the interface apparatus by auxiliary approaches such as vacuum attaching or mechanical holding.

4. The method of assembling an LCD panel of claim 1, wherein step (d) further comprises the step of:
(d1) supporting the first panel assembly with a linear motion device, to keep the first panel over the second panel.

5. The method of assembling an LCD panel of claim 1, wherein step (d) further comprises the step of:
(d2) applying a magnetic force upward to the interface apparatus with an electromagnetic device, to keep the first panel over the second panel.

6. The method of assembling an LCD panel of claim 1, wherein a guiding device is disposed in the assembly room for guiding the position and the moving direction of the interface apparatus.

7. The method of assembling an LCD panel of claim 1, wherein step (d) further comprises the step of:
(d3) mounting the first panel assembly on an upper press block, to keep the first panel over the second panel.

8. An interface apparatus for assembling a first panel and a second panel in an assembly room, the second panel being mounted in the assembly room, the interface apparatus comprising:
a panel-mounting interface for mounting the first panel; and
an actuating interface for serving as a carrying interface of a transportation device and for bearing an external force to make the interface apparatus move relative to the second panel.

9. The interface apparatus of claim 8, wherein the external force is generated by a linear motion device, the actuating interface bears the external force to make the interface apparatus move relative to the second panel.

10. The interface apparatus of claim 8, wherein the external force is generated by an electromagnetic device, the actuating interface bears the external force to make the interface apparatus move relative to the second panel.

11. An assembling apparatus for assembling a first panel and a second panel, the assembling apparatus comprising:
an assembly room, comprising:
a panel actuating device; and
an air pressure control device for controlling the air pressure in the assembly room; and
a lower press block being disposed in the assembly room, the lower press block comprising:
a panel-mounting interface for mounting the second panel; and
an adjusting device for adjusting the position of the second panel;
wherein the panel actuating device makes the first panel move relative to the second panel so as to press the first panel assembly with the second panel mounted on the lower press block.

12. The assembling apparatus of claim 11, wherein the panel actuating device is a linear motion device for making the first panel assembly move relative to the second panel.

13. The assembling apparatus of claim 11, wherein the panel actuating device is an electromagnetic device for applying a magnetic force to the first panel, to make the first panel assembly move relative to the second panel.

14. The assembling apparatus of claim 11, wherein the assembly room further comprises a guiding device for guiding the first panel assembly during the motion of the first panel relative to the second panel.
